(19) United States
(12) Patent Application Publication
(10) Pub. No.: US 2005/0028730 A1
(43) Pub. Date: Feb. 10, 2005

(54) Breading table

(76) Inventors: Kwang Hwee Chua, Singapore (SG); Kin Mun Chew, Singapore (SG)

Correspondence Address: Mr. Marc D. Machtinger, Esq.;Law Office of Marc D. Machtinger, Ltd., Suite 350, 750 W. Lake Cook Road, Buffalo Grove, IL, 60089-2073, US

(21) Appl. No.: 10/785,663

(22) Filed: Feb. 23, 2004

Related U.S. Application Data
(63) Continuation-in-part of application No. 29/164,003, filed on Sep. 11, 2002, now Pat. No. D494805.

(30) Foreign Application Priority Data
Apr. 23, 2002 (SG) D2002/385/Z

(51) Int. Cl. A23G 3/20

(52) U.S. Cl. 118/13

(57) ABSTRACT

A breading table having a front loading configuration is disclosed. The breading table includes a top surface having a cut-out section, and a front surface having a front cut-out section, such that a breading bin can be loaded in and out of the table from the front without requiring the user to lift the bin above the top surface of the table. In various configurations, the front cut-out section includes a clearance cut-out section for placing a hand beneath the bin while loading or unloading. The breading table optionally includes a bin drain hole for excess flour to pass through to a sifter, which separates loose flour from clumped dough. The loose flour passes through to a collection bin, and the dough is urged toward a dough collection compartment. In various embodiments, the table includes a back surface, or two collection bin stations.

### CROSS-REFERENCE TO RELATED APPLICATIONS

This is a continuation-in-part application of U.S. patent application No. 29/164,003, filed Sep. 11, 2002, which is hereby incorporated by reference herein in its entirety.

### TECHNICAL FIELD

The present invention relates to a breading table, and more particularly, to a breading table having a front loading breading bin.

### BACKGROUND OF THE INVENTION

In the restaurant industry, various foods are breaded in large quantities. Foods such as chicken are breaded and fried, and many portions must be similarly prepared. It is thus convenient for restaurants to make use of equipment such as breading tables to process the quantities required.

Various breading tables have been utilized for the purpose of breading food items in restaurant settings. Such tables typically include a bin for coating the food items with flour. Some such bins allow the preparer to push the excess flour through a hole in the bottom of the bin. Some of the flour which is allowed to pass through this hole is clumped together into a dough. Other flour may be reusable.

During usage, such bins are typically removed from and replaced in such breading tables. The removal and replacement of the bins typically occurs by a user manually lifting the bins out from an opening in the top surface of the table, and lifting the bin above the table to place it into such an opening. Lifting such a bin above the surface of a table numerous times in a day can take a physical toll on the user. In fact, such tasks can cause various hardships such as back pain or injury.

Therefore, it would be advantageous to provide a breading table having certain ergonomic features which address the above discussed problem, in combination with various features and advantages.

### SUMMARY

In view of the deficiencies described above, it is an object of the present invention to provide an ergonomic breading table with various features and advantages.

The present invention is a breading table having an ergonomic front-loading configuration. The breading table of the present invention has a top surface with a cut-out section, and a front surface having a front cut-out section such that a user can load the bin into the table without the need to lift the bin above the top surface of the table. This front-loading configuration facilitates easy loading and unloading with decreased difficulty, discomfort, or injury.

The table of the present invention includes various combinations of advantageous features in various embodiments. In various embodiments, the bin has a lip or flange which supports the bin on the top surface along the edge of the top cut-out section. The front cut-out surface includes an optional clearance cut-out section which allows the user to place a hand underneath the breading bin to support it while loading or removing it.

In various embodiments, the breading bin includes a hole or drain at the center of the bottom surface of the bin. In use, the user breads food items in the bin, and pushes excess flour through the hole. The excess flour falls to a sifter below the breading bin. Loose flour is allowed to pass through the sifter to a collection bin. The sifter is optionally driven via a motor contained within the housing of the table. Typically, the sifter would rock back and forth. The sifter is optionally biased or sloped toward one side such that flour which is clumped together into a mass of dough is urged toward a dough collection compartment, as the loose flour passes through the sifter. The loose flour collected in the collection bin can then be reused.

In certain preferred embodiments of the invention, the breading table is configured with a back surface extending above the top surface. In further embodiments, a dual breading bin configuration is provided such that two stations for breading are provided.

Other features and advantages of the present invention will be apparent from the following detailed description taken in conjunction with the following drawings.

### BRIEF DESCRIPTION OF THE DRAWINGS

FIG. 1 is a perspective view of one embodiment of the present invention, showing the bin installed in the table.

FIG. 2 is a perspective view of one embodiment of the present invention, with the bin removed from the table.

FIG. 3 is a perspective view of another embodiment of the present invention.

FIG. 4 is a perspective view of another embodiment of the present invention showing a dual bin configuration.

FIG. 5 is a perspective view of another embodiment of the present invention showing a dual bin configuration.

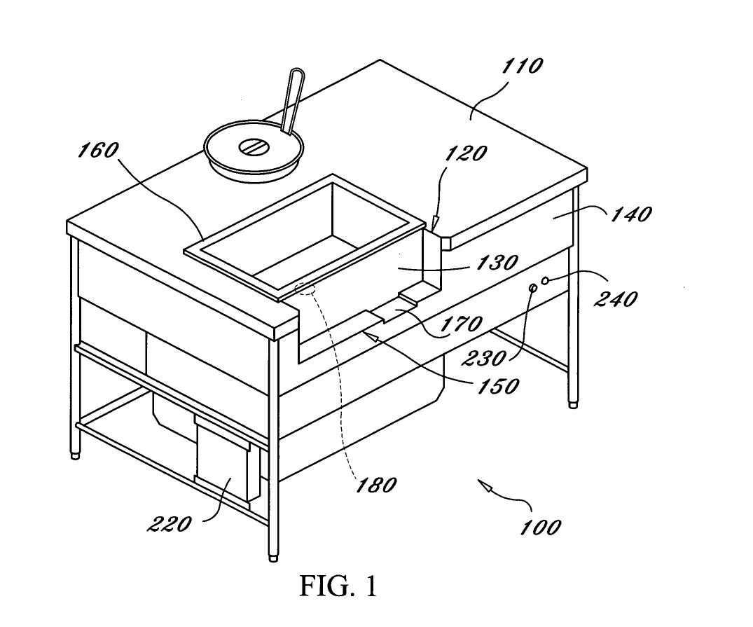

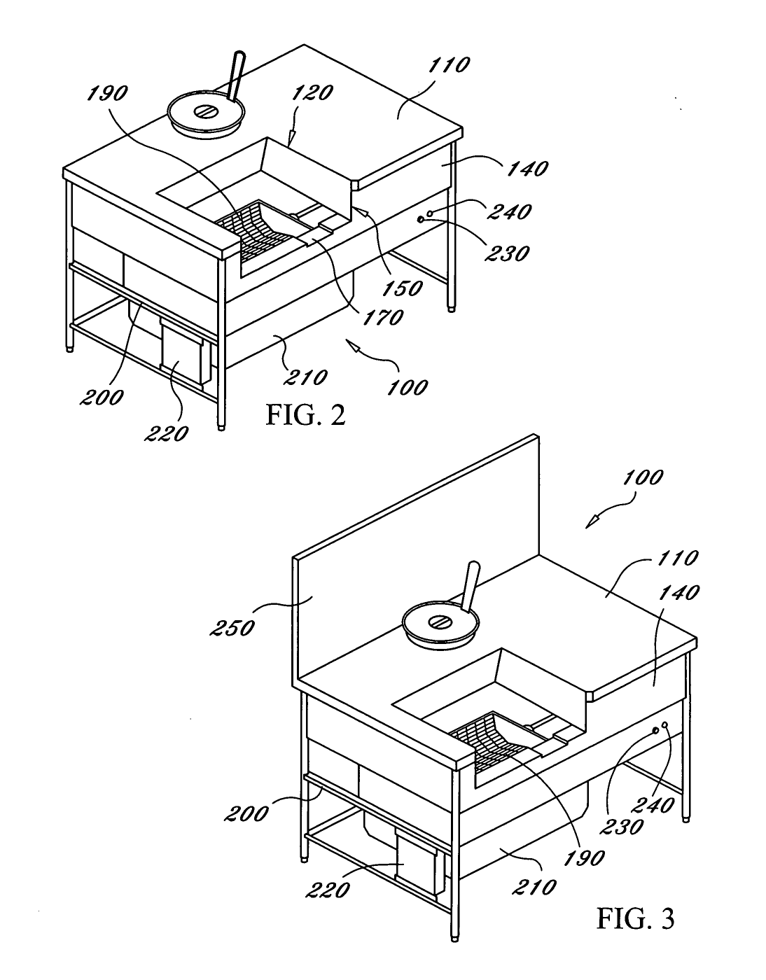

### DETAILED DESCRIPTION

While this invention is susceptible of embodiments in many different forms, there are shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention is a breading table 100. The table 100 includes a top surface 110 having a top cut-out section 120 adapted to receive a breading bin 130. The breading table 100 further comprises a front surface 140 having a front cut-out section 150 adapted to enable insertion of the breading bin 130. The breading bin 130 can thus be loaded or unloaded via the front cut-out section 150 without lifting the bin 130 substantially above the top surface 110.

The breading bin 130 optionally includes a lip or flanged portion 160 to support the bin 130 on the top surface 110. The front cut-out section 150 optionally includes a clearance cut-out section 170 adapted to enable a hand to be placed underneath the bin 130 when the bin 130 is installed within the breading table 100.

In various embodiments, the breading table 100 of the present invention includes a drain or hole 180 in the bottom surface of bin 130 through which unused flour can be passed. The hole 180 can be plugged during breading, or unplugged to allow passage of flour. Flour passed through the hole 180 falls to a sifter 190 disposed below the bin 130. Sifter 190 is optionally operated via a motor (not shown) within the housing of the table 100. The motor causes the sifter 190 to rock back and forth rapidly, allowing loose flour to pass through the sifter 190 into a collection bin 210.

In various embodiments, the sifter 190 has a concave upper surface facing upward, and is biased to one side such that clumps of flour or dough will be urged toward a dough collection compartment 220 during operation of the sifter 190. The dough collection compartment 220 is optional removable, and collected dough can easily be discarded.

Optionally, one or more shock absorbing apparatus 200 dampen vibrations from the motor. The breading table 100 optionally further comprises a control 230 for operating the motor. Control 230 can be used to activate or deactivate the motor. Optionally, the motor may be deactivated by a timer after running for a fixed period of time. The breading table 100 optionally includes an indicator 240 to indicate when the motor is in operation.

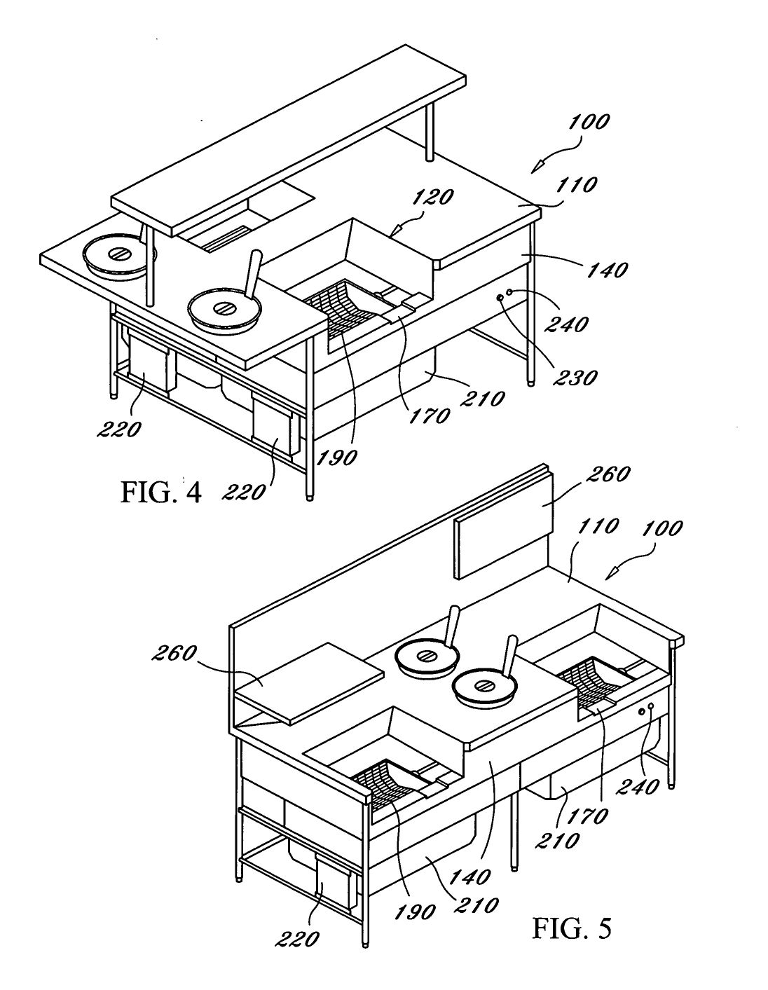

In various further embodiments, the breading table 100 optionally includes a back surface 250 extending upward from the top surface 110 of the breading table 100, as illustrated in FIG. 3. Thus, the back surface 250 shields against spillage or splashing during use of the table 100. The back surface 250 optionally includes a fold down shelf 260 for convenience, as shown in FIG. 5.

FIGS. 4 and 5 illustrate configurations having dual breading stations comprising a second top cut-out section 120 adapted to receive a second breading bin 130, and a second front cut-out section 150 adapted to enable insertion of the second breading bin 130. In these dual station configurations, the second bin 130 can also be front-loaded via the second front cut-out section 150 without lifting the second bin 130 substantially above the top surface 110. Such dual station configurations allow the use of the breading table 100 by more than one user at one time, or may allow for each station to be used for a different purpose or different food item.

The present invention further includes a method for manufacturing a breading table 100 which includes the steps of providing a top surface 110 having a top cut-out section 120 adapted to receive a breading bin 130, and providing a front surface 140 having a front cut-out section 150 adapted to enable insertion of the breading bin 130. In the method, the table 100 is configured such that bin 130 can be front-loaded via the front cut-out section 150 without lifting the bin 130 substantially above the top surface 110 of the table 100.

In further embodiments, the method includes providing the front cut-out section 150 with a clearance cut-out section 170 adapted to enable a hand to be placed underneath the bin 130 when the bin 130 is installed within the breading table 100. Thus, a user can easily support and control the bin 130 during installation and removal.

While the specific embodiments have been illustrated and described, numerous modifications come to mind without significantly departing from the spirit of the invention, and the scope of protection is only limited by the scope of the accompanying claims.

1. A breading table comprising:
a top surface having a top cut-out section adapted to receive a breading bin,
a front surface having a front cut-out section adapted to enable insertion of said breading bin,
wherein said bin can be front loaded via said front cut-out section without lifting said bin substantially above said top surface.

2. The breading table according to claim 1, wherein said front cut-out section further comprises a clearance cut-out section adapted to enable a hand to be placed underneath said bin when said bin is installed within said breading table.

3. The breading table according to claim 1, wherein said breading bin comprises a bottom surface having a hole therethrough, and wherein said breading table further comprises a sifter disposed under said breading bin, and a flour collection bin disposed under said sifter.

4. The breading table according to claim 3, wherein said sifter has a substantially concave surface facing upward, wherein said sifter is biased toward one side, and further comprising a dough collection compartment, wherein said sifter operates via repeated motion back-and-forth, and wherein dough which passes through said hole from said breading bin to said sifter is advanced toward said dough collection compartment during operation of said sifter.

5. The breading table according to claim 4, wherein said sifter operates via a motor housed within said breading table.

6. The breading table according to claim 5, wherein said front cut-out section further comprises a clearance cut-out section adapted to enable a hand to be placed underneath said bin when said bin is installed within said breading table.

7. The breading table according to claim 5, further comprising at least one shock absorbing apparatus for dampening vibration due to said motor.

8. The breading table according to claim 5, wherein said breading table further comprises a control for operating said motor.

9. The breading table according to claim 8, wherein said motor is controlled via a timer for automatically shutting off said motor after a fixed amount of time.

10. The breading table according to claim 2, wherein said breading bin comprises a flanged portion for supporting said bin on said top surface of said breading table.

11. The breading table according to claim 10, further comprising a back surface extending upward from said top surface of said breading table.

12. The breading table according to claim 11, wherein said back surface further comprises a fold down shelf.

13. The breading table according to claim 10, wherein said table comprises a second top cut-out section adapted to receive a second breading bin, and
a second front cut-out section adapted to enable insertion of said second breading bin,
wherein said second bin can be front loaded via said second front cut-out section without lifting said second bin substantially above said top surface.

14. A method for manufacturing a breading table comprising:
providing a top surface having a top cut-out section adapted to receive a breading bin,
providing a front surface having a front cut-out section adapted to enable insertion of said breading bin,
wherein said bin can be front loaded via said front cut-out section without lifting said bin substantially above said top surface.

15. The method for manufacturing a breading table according to claim 14, further comprising providing said front cut-out section with a clearance cut-out section adapted to enable a hand to be placed underneath said bin when said bin is installed within said breading table.
